(19) United States
(12) Patent Application Publication
(10) Pub. No.: US 2006/0148655 A1
(43) Pub. Date: Jul. 6, 2006

(54) Use of a selected legume starch in an industrial fluid

(75) Inventors: Leon Mentink, Roubaix (FR); Jean-Pierre Graux, Lillers (FR)

Correspondence Address: YOUNG & THOMPSON, 745 SOUTH 23RD STREET, 2ND FLOOR, ARLINGTON, VA, 22202, US

(73) Assignee: ROQUETTE FRERES, LESTREM CEDEX (FR)

(21) Appl. No.: 10/546,606

(22) PCT Filed: Feb. 18, 2004
(86) PCT No.: PCT/FR04/00384

§ 371 Date: Aug. 23, 2005

(30) Foreign Application Priority Data
Feb. 24, 2003 (FR) 03/02223

(51) Int. Cl. C09K 8/035

(52) U.S. Cl. 507/111

(57) ABSTRACT

an industrial fluid includes a selected legume starch with a Brookfield viscosity of between 100 and 20 000 mPa.s, as component of the industrial fluid. The legume starch preferably also has a solubility in water of between 10 and 85%. The industrial fluid is particularly a fluid for use in boreholes with a pH greater than 8.5 and which can be used at a temperature above 130° C. The invention further relates to a method for preparation of a legume starch, selected thus by the viscosity thereof and also several families of novel legume starches, characterized by particular ranges of viscosity and aqueous solubility.

The present invention relates to the use of a legume starch, which is selected for its viscosity characteristics and, where appropriate, for its solubility characteristics, as a constituent of an industrial fluid.

The invention also relates to a process for preparing a legume starch which has been selected in this way.

The invention relates, very particularly, to the use of a legume starch which has been prepared or selected in this way, as a constituent of a fluid which is intended for the field of drilling wells (boreholes).

Within the meaning of the present invention, “legume” is understood as signifying any plant which belongs to the caesalpiniaceae, mimosaceae or papilionaceae families and, in particular, any plant which belongs to the papilionaceae family such as, for example, pea, bean, broad bean, horse bean, lentil, alfalfa, clover or lupin.

This definition includes, in particular, all the plants which are described in any one of the tables contained in the article by R. Hoover et al. entitled “Composition, Structure, functionality and Chemical modification of legume starches: a review”.

The legume is preferably selected from the group comprising pea, bean, broad bean and horse bean.

Advantageously, the legume is pea, with the term “pea” being in this present case considered in its widest sense and including, in particular:

all the wild-type varieties of “smooth pea”, and

all the mutant varieties of “smooth pea” and of “wrinkled pea”, with this being the case irrespective of uses for which said varieties are generally intended (human nutrition, animal nutrition and/or other uses).

Said mutant varieties are, in particular, those designated “r mutants”, “rb mutants”, “rug 3 mutants”, “rug 4 mutants”, “rug 5 mutants” and “lam mutants”, as described in the article by C-L Hedley et al. entitled “Developing novel pea starches” Proceedings of the Symposium of the Industrial Biochemistry and Biotechnology Group of the Biochemical Society, 1996, pp 77-87.

According to another advantageous variant, the legume is a plant, for example a variety of pea or of horse bean, which gives seeds which contain at least 25% by weight (dry/dry) of starch.

A “legume starch” is understood as meaning any composition which is extracted, by whatever means, from a legume, and, in particular from a papilionacea, and whose starch content is greater than 90%, preferably greater than 95%, with these percentages being expressed in dry weight based on the dry weight of said composition.

Advantageously, this starch content is at least equal to 98% (dry/dry).

According to another variant, the protein content of said composition is less than 5%, preferably less than 2%, with these percentages being expressed in dry weight based on the dry weight of said composition.

Advantageously, this protein content is at most equal to 1% (dry/dry), preferably at most equal to 0.5%. It can, for example, be between 0.25 and 0.45%.

The composition which can be used as “legume starch” within the meaning of the present invention can additionally contain, generally at a total content of less than 5% (dry/dry), other constituents which are different from starch and protein, in particular fatty substances, colloidal substances, fibers, mineral constituents, etc.

The amylose content of the starch which is contained in said composition can vary over a wide range, i.e. be between 3 and 80% and, generally between 10 and 78%, with these percentages being expressed in dry weight based on the dry weight of starch contained in said composition.

According to a first variant, this amylose content is greater than 20% and less than 60%, and is, in particular, between 22 and 55% (dry/dry).

Particularly advantageously, this amylose content is greater than 32% and less than 53%, and is, in particular, between 33 and 45% (dry/dry).

The starch which is contained in said composition can, in particular, have been subjected to at least one modifying treatment which is selected from the group comprising chemical treatments, physical treatments and enzymatic treatments.

The chemical treatments comprise, in particular, all the known processes of esterification, etherification, crosslinking or hydrolysis by means of acid or oxidation.

The physical treatments comprise, in particular, all the known processes of precooking, cooking, extrusion, atomization or drying, those known under the terms “heat moisture treatment” or “annealing”, and the processes of microwave or ultrasonic treatment, of plasticization or of granulation.

The use of starches and of starch derivatives derived from plants other than legumes, in particular derived from potato, corn or wheat, as constituents of industrial fluids is described very widely in the literature.

In this present case, “industrial fluid” is understood as meaning any fluid which is not for nutritional, pharmaceutical or cosmetological use, with this fluid:

generally being present in the form of an aqueous suspension, solution or dispersion, of a water-in-oil emulsion or of an oil-in-water emulsion, and

advantageously exhibiting one or more of the following properties: viscosifying, lubricating, cooling, anticorrosion and/or temporary protection.

The industrial fluids can, for example, be industrial fluids which are used as:

machining fluids, as described in the patent EP 649 460 in the name of the Applicant,

baths for tempering metals, as described in the patents FR 2 530 668 and FR 2 671 103 in the name of the Applicant, or

compositions for temporarily protecting objects, in particular metallic objects, as described in the patent FR 2 508 051 in the name of the Applicant.

“Industrial fluid” is understood as meaning, in particular, any composition which can be used as a fluid for wells (“well servicing fluid”) within the meaning of the patents FR 2 516 532 and U.S. Pat. No. 4,392,964.

While this definition includes drilling fluids or drilling muds, it also includes workover fluids, completion fluids, packer fluids, well treating fluids, subterranean fluids, spacer fluids and hole abandonment fluids.

The starches and derivatives originating from plants other than legumes have been widely used for more than sixty years in the preparation of fluids for wells, in particular drilling fluids or drilling muds.

Examples of a use of this nature are provided, inter alia, in the patents FR 1 244 623, FR 2 206 375 or CA 1077699, or, more recently, in the patents U.S. Pat. No. 6,133,203, U.S. Pat. No. 6,281,172, EP 1 130 074, U.S. Pat. No. 6,391,830 or U.S. Pat. No. 6,180,571.

To the Applicant's knowledge, the only document which provides an actual example of the use of a legume starch as a constituent of an industrial fluid, in this instance a drilling mud, consists of the patent application WO 02/12414 entitled “Drilling fluid comprising a high-amylose starch”.

This document recommends physically modifying, very specifically by extrusion, the legume starch for using it in the drilling mud.

However, no detail is given, or can be deduced, with regard to the conditions for extruding said starch and therefore with regard to the intrinsic characteristics, in particular the solubility and viscosity characteristics, of the resulting extruded starch, included in the table which is located on page 9 of this document and which is entitled “Temperature Tolerance Extruded Legume Starch”.

This table specifically measures the characteristics (including FANN viscosity) of application compositions of the “drilling mud” type based on NaCl, on clay and on extruded starch (10 g/l), with the said characteristics furthermore being measured at the sole temperature of 150° C.

Similarly, the intrinsic characteristics of the legume starch containing 32% amylose (designated “product”) which is used in the drilling muds (“mud compositions I-IV”) which are described on pages 7 and 8 of this application are not specified nor is it possible to deduce them.

In addition, no details are given as to the true contents in starch, proteins, colloidal substances, fibers, lipids and other possible constituents in the products which are employed in these examples.

Furthermore, the examples of drilling muds which are given in this document are always tested under pH conditions which can be judged as being rather favorable.

Thus, the pH values of said drilling muds are always between 7.8 and 8.3 and therefore always at a pH value of less than 8.5, i.e. within a pH range which is not particularly alkaline as compared with those which are most commonly envisaged within this application.

These conditions limit the possibilities of the starch becoming thermochemically destabilized during the preparation, and then the use, of the drilling mud and, in the same way, overestimate the efficacy of said starch, in particular as an additive which is viscosifying and capable of limiting the fluid loss of said mud.

In addition, the highly swelling nature of the clays (attapulgite and bentonite) which are employed in the drilling muds (“mud compositions I-IV”) described on pages 7 and 8 of the abovementioned WO 02/12414 application is also capable of limiting the loss of fluid form the drilling muds.

The Applicant then found that it was possible, by appropriately selecting certain physicochemical characteristics of legume starches, to advantageously improve the possibilities of using said starches as constituents of industrial fluids, in particular those which can be used under conditions involving high temperatures and/or high pH values.

In this present case, “high temperatures” are understood as being temperatures higher than 130° C., preferably higher than 135° C. and, in particular, at least equal to 140° C., to which temperatures said industrial fluids are subjected during use.

In this present case, “high pH values” are understood as meaning pH values which are at least equal to 8.5, which are preferably between 8.5 and 12 and which are, in particular, between 9 and 11.5 on a par with the pH values of said industrial fluids as prepared for their uses.

The Applicant has, in particular, observed, after extensive research and analytical work, that selecting the viscosity characteristics of a legume starch, for example of a pea starch, advantageously improved the possibilities of using the starch as a constituent of well fluids which can be used concomitantly at high temperatures and high pH values.

Following on from which, the present invention relates to the use of a legume starch which exhibits a Brookfield viscosity of between 100 and 20 000 mPa.s as a constituent of an industrial fluid.

The concepts “legume starch” and “industrial fluid” have been previously defined.

The “Brookfield viscosity” of the legume starch which can be used in accordance with the invention is measured traditionally in accordance with the instructions, and on an apparatus, supplied by Brookfield Engineering Laboratories, Inc.

In the present case, this viscosity is measured at 20° C. on an aqueous composition containing 8% (dry weight) of said starch, which composition has been stirred for 20 minutes at 1500 revolutions/minute.

This viscosity (“Brookfield viscosity (8%, 20° C., 20 min, 1500 revolutions/minute”) below) can, in particular, be measured in accordance with the protocol which is described below:

the precise water content of the legume starch to be tested is determined, for example using an infrared moisture balance of the “Sartorius MA 30” type,

the quantity of water which has to be added to 40 g, expressed as dry weight, of said starch in order to obtain an aqueous composition whose dry matter content is 8% is then calculated,

the quantity of water (drinking water at 20° C.) which has thus been calculated is introduced into a 1 l stainless beaker,

this water is stirred (500 revolutions/minute) using a laboratory stirrer, for example of the “Turbotest 33/300 S” type fitted with a deflocculating turbine which has a diameter of 55 mm and which is supplied with this apparatus,

during this stirring, the 40 g, expressed in dry weight, of legume starch to be tested are introduced over a period of a few seconds,

as soon as all said starch has been introduced into the water, the stopwatch is started,

the rate of stirring is increased to 1500 revolutions/min and this stirring is maintained for 20 minutes,

the Brookfield viscosity of the resulting aqueous composition is then determined immediately, for example on a “Brookfield model RVF 100” instrument and using the spindle of the device which gives a reading between 20 and 80% of the scale on the dial of the device,

this value is in the present case taken as the Brookfield viscosity (8%, 20° C., 20 min, 1500 revolutions/min) of the legume starch which has been tested.

According to a preferred variant, the legume starch which can be used as a constituent of an industrial fluid in accordance with the invention exhibits a Brookfield viscosity, which has been measured in this way, of between 200 and 18 000 mPa.s, in particular of between 500 and 15 000 mPa.s.

As will additionally be demonstrated by examples, this viscosity can advantageously be between 1000 and 10 000 mPa.s.

After a large number of research and analytical studies, the Applicant company found that legume starches which were selected within the above-described viscosity ranges were particularly suitable for being used as constituents of industrial fluids under conditions of high temperatures and/or high pH values while at the same time remaining sufficiently stable and workable during operations carried out at ambient temperature (20° C.).

In the specific field of fluids for wells, the Applicant company observed, in particular, that employing these selected legume starches enabled said fluids:

to be utilizable, if it was so desired, at temperatures which were at least equal to 135° C., or even at least equal to 141° C. or 144° C., i.e. temperatures which may reached at the bottoms of wells during deep drillings,

to be utilizable, if so desired and including at the abovementioned temperatures, for high pH ranges, for example pH values of between 8.5 and 12,

to be utilizable, if so desired and including the abovementioned temperatures and pH values, in a great variety of environments, for example in terms of the salinity of the medium (including saturated or unsaturated salinated water or brine, seawater, which is reconstituted where appropriate, etc.),

to exhibit, at ambient temperature, good physical properties, in particular with regard to stability and viscosity,

to exhibit, at ambient temperature or not, good application properties, for example good capacity for forming filtration cakes on the walls of the wells.

The Applicant company then found that these advantages were even more readily obtained if the legume starch which had been selected in this way for its intrinsic viscosity was, in addition, selected for its solubility in water.

In this present case, “solubility in water” is understood as meaning the percentage by weight of substances which are contained in said starch and which are soluble in distilled water at 20° C.

In the present case, a sample of about 5 g of legume starch is taken. The precise weight (designated “W”) of said sample is measured.

200 ml of distilled water, and then the abovementioned quantity W of legume starch, are introduced, at 20° C. and while stirring, into a 250 ml beaker. After 15 minutes of stirring, the resulting composition is centrifuged for 10 minutes at 4000 revolutions/minute and at 20° C.

After centrifugation, 25 ml of supernatant liquid are withdrawn and introduced into a glass crystallizing dish which has a diameter of 95 mm and which has previously been dried and weighed.

The crystallizing dish is then placed in an aerated oven whose temperature is maintained at approximately 60° C. After the water has evaporated, the crystallizing dish is placed in a circulating-air oven set to 103° C.±2° C. for 1 hour and then into a desiccator for cooling the sample down to ambient temperature.

The quantity, designated “M”, of sample contained in the crystallizing dish is then weighed.

The solubility in water of the legume starch which has been tested, expressed in %, is calculated in accordance with the following formula:

$$Solubility in water ( \% ) = \frac{M \times 200 \times 100}{25 \times W}$$

The Applicant company found that, within the context of the invention, it was advantageous to use legume starches exhibiting, in addition to a viscosity within the abovementioned ranges, a solubility in water (measured as described above) which is selected within an equally specific range, in this case between 10 and 85%.

According to a preferred variant, this solubility in water is between 10 and 80%, in particular between 12 and 80%.

In particular, it was observed that legume starches which simultaneously exhibited:

a Brookfield viscosity (8%, 20° C., 20 min, 1500 revolutions/min) of between 500 and 15 000 mPa.s, in particular of between 1000 and 10 000 mPa.s, and

a solubility in water of between 10 and 80%, in particular of between 12 and 80%, are remarkably suitable for use as constituents of well fluids, in particular of drilling fluids having pH values greater than 8.5 and being intended for use at temperatures at least equal to 140° C., for example of about 141-144° C.

Two families of products which were particularly suitable for being used in accordance with the invention and, in particular, in the abovementioned well fluids, were found, in particular, among these legume starches which were selected in accordance with the double criterion of viscosity and solubility in water.

The first family (thereafter designated as “FAMILY 1”) covers legume starches which simultaneously exhibit:

a Brookfield viscosity of between 2000 and 8000 mPa.s, and

a solubility in water of between 15 and 50%.

The second family (thereafter designated as “FAMILY 2” below) consists of legume starches which simultaneously exhibit:

a Brookfield viscosity of between 500 and 1900 mPa.s, and

a solubility in water of between 30 and 80%.

The Applicant company furthermore considers that the legume starches of the two FAMILIES 1 and 2 which have thus been selected, constitute novel industrial products.

In a general manner, the legume starch which can be used as a constituent of industrial fluid in accordance with the invention can, in particular, as described above:

exhibit variable contents of starch, amylose, proteins, fatty substances, fibers, colloidal substances and mineral constituents, and

have been subjected to at least one modification by means of a chemical or physical treatment.

Following on from which, the present invention also relates to a process for preparing a modified legume starch which can be used as a constituent of an industrial fluid, characterized in that a legume starch is subjected to at least one chemical or physical treatment, such that the resulting legume starch complies with any one of the above-described Brookfield viscosity ranges and, where appropriate, with any one of the above-described ranges of solubility in water.

According to a first variant, a legume starch is subjected to a physical treatment, in particular cooking or precooking, other than an extrusion treatment and, in particular, to a treatment on any device which is widely known to the skilled person under the general term “drum dryer”, including monocylindrical (“single drum”) and “bicylindrical” (“double drum”) variants.

The Applicant company found that the treatments on a drum dryer were particularly suitable for efficiently preparing legume starches which were selected in accordance with the present invention, including for efficiently preparing the abovementioned two FAMILIES 1 and 2 of novel industrial products selected in accordance with the double criterion of viscosity and of solubility in water.

These treatments have proven to be particularly suitable for preparing legume starches which belong to the abovementioned FAMILY 1.

Moreover, the Applicant company observed that the drum treatments made such an efficient preparation possible by employing native legume starches as the starting materials, i.e. legume starches which had not previously been subjected to any chemical, physical or enzymatic modification.

This does not, of course, exclude that these drum treatments may be carried out on legume starches which are previously, simultaneously and/or subsequently modified in one way or another.

The treatment on a drum dryer can, for example, be preceded by another treatment, in particular by another physical treatment such as passage through a nozzle or any other device for cooking, either directly by steam jet or indirectly, which enables a starch suspension to be cooked instantaneously.

In addition, the Applicant company also observed that extrusion treatments enabled such an efficient preparation to be achieved when, contrary to the teachings of the WO 02/12414 application, legume starches which had previously been chemically modified, in particular weakly crosslinked, were employed as starting materials.

Following on from which, the process of preparing a modified legume starch in accordance with the present invention can also be characterized:

in accordance with one variant, by the fact that a native, or previously modified, legume starch is subjected to a treatment other than an extrusion treatment, in particular to a drum dryer treatment,

in accordance with another variant, by the fact that a chemically modified, in particular crosslinked, legume starch is subjected to an extrusion treatment.

It is, in particular, to the Applicant's credit to have found not only that these two process variants were particularly suitable for preparing the two abovementioned FAMILIES 1 and 2 of novel legume starches which were selected in accordance with the double criterion of viscosity and solubility in water, but also that said starches were particularly efficient as constituents of industrial fluids which exhibited high pH values, i.e. at least equal to 8.5, and/or which could be used at high temperatures, i.e. greater than 130° C.

In particular, said legume starches which have thus been selected have proven to constitute remarkably efficient constituents of well fluids, in particular of drilling fluids, which exhibit pH values of between 9 and 11.5 while, at the same time, being able to be used at temperatures of at least 140° C.

According to one variant of the present invention, at least one legume starch belonging to the abovementioned FAMILY 1 and at least one legume starch belonging to the abovementioned FAMILY 2 are combined within one and the same well fluid.

It is entirely surprising to note that said starches exhibit, not only at ambient temperature but also at a high temperature, the physical characteristics which are necessarily required, in accordance with the current specifications, for example the specifications published by the American Petroleum Institute (“API”), for using said starches as water-retaining agents in drilling muds.

The legume starches which are thus selected in accordance with the invention differ, in particular:

from starches derived from potato, corn or waxy maize, which starches, necessarily have to be crosslinked to a very high level in order to be effective at high temperature, and

from amylose-rich corn starches, which do not exhibit at ambient temperature the required physical characteristics, in particular in terms of viscosity, solubility and conformity with the API test.

According to one variant of the present invention, it is possible, however, to combine, within one and the same industrial fluid, for example within one and the same well fluid:

at least one legume starch which can be used in accordance with the invention and which belongs, in particular, to one or the other of the abovementioned FAMILIES 1 and 2, and

at least one starch which is not derived from a legume, preferably a corn starch and, very particularly, a corn starch having an amylase content of greater than 45%, and in particular between 46 and 75%.

Said starch which is not derived from a legume can advantageously have an amylose content of between 46 and 60% approximately. The starch can be native or have been subjected to at least one physical and/or chemical modification, wherein said modification may have been carried out simultaneously or not with the possible modification which the legume starch employed in accordance with the present invention may have undergone.

It will be possible to understand the invention more readily with the aid of the following examples which report certain advantageous modes of preparing the legume starches in accordance with the invention and of using them in the general field of industrial fluids.

### EVALUATION PROTOCOLS FOR THE FIELD OF WATER-BASED DRILLING FLUIDS

The methods for evaluating starches, which are in accordance with the invention or not, as potential constituents of water-based drilling fluids, in particular as filtrate-reducing agents, are described below.

This method consists in evaluating the physical properties of said starches in accordance with the API 13 A specification (“API Specification 13A—Fifteenth edition, May 1993”) and, more specifically, in accordance with “Section 11—Starch” on pages 33-35 of said specification.
1) General Protocol

Starting with a given starch, the following respective drilling fluids are prepared and evaluated:

based on salinated water containing 40 g/l NaCl (“40 g/l salt water”), i.e. fluids whose viscosity V is measured at 600 rpm and whose filtration volume F is calculated in accordance with paragraphs 11.3 and 11.4 of said specification, and

based on saturated salinated water (“saturated salt water”), i.e. fluids whose viscosity V′ is measured at 600 rpm and whose filtration volume F′ is calculated in accordance with paragraphs 11.5 and 11.6 of said specification.

The clay which is used for this evaluation is a low-swelling base clay which conforms with the API standard (“API standard evaluation base clay”), in this particular case of the “Hymod Prima” type from Dowell-Schlumberger.

The values of V, F, V′ and F′ which are obtained are then compared with the maximum values given in Table 11.1 “Starch physical requirements” on page 33 of said specification.

According to said table, the maximum values which can be achieved for a product to be considered acceptable for the intended application, are as follows:

V=18

V′=20

F=10 cm³, and

F′=10 cm³

For the sake of simplification, it is consequently considered that a given starch exhibits satisfactory physical characteristics when all the values V, F, V′ and F′ are at most equal to the abovementioned values (respectively, 18, 20, 10 cm³ and 10 cm³). By convention, such a starch is provided with the sign “+”.

Conversely, a starch is not considered to exhibit (totally) satisfactory physical characteristics when at least one of the values V, F, V′ and F′ (a fortiori all the values V, F, V′ and F′) is greater than the abovementioned corresponding maximum value. By convention, such a starch is provided with the sign “−”.

The previously described GENERAL PROTOCOL studies the behavior of a given starch without the latter having undergone, after its preparation, any specific thermal or physical post-treatment.

Following on from which, the GENERAL PROTOCOL is in this present case regarded as having been carried out “at ambient temperature” or, more precisely, at “low temperature/low pressure” and will be designated “LTLPT” (for “low temperature/low pressure test”) below.
2) Specific Protocol

The Applicant company has also studied the behavior of a certain number of starches in accordance with the above-described GENERAL PROTOCOL but after these starches have been subjected, within a drilling fluid, to a treatment which will be described below and which, by convention, will be designated “HTHPT” (for “high-temperature/high-pressure test”).

For the purpose of carrying out this “HTHPT” test, a “synthetic” seawater of the following composition is prepared:

| | | |
|---|---|---|
| demineralized water | 960.00 | g |
| NaCl | 25.60 | g |
| MgCl₂ 6H₂O | 5.13 | g |
| MgSO₄ 7H₂O | 3.30 | g |
| KCl | 0.73 | g |
| NaHCO₃ | 0.20 | g |
| NaBr | 0.20 | g |
| CaCl₂ 2H₂O | 1.45 | g |

350 ml of the “synthetic” seawater which have been prepared in this way and 35 g of “Hymod Prima” clay are then mixed at 500 rpm for 30 minutes. The pH of this composition is then adjusted to a value of 10 with 400 g/l sodium hydroxide solution. 350 ml of this composition are then mixed with 5 g of the starch to be tested, with mixing carried out at 11 000 rpm for 20 minutes in a mixer of the “Hamilton Beach” type.

The mud which is obtained is poured into a stainless steel cell so as to reach a level situated 1 cm below the upper edge of said cell.

The cell containing the mud is put under nitrogen pressure (100 psi, that is approximately 6.9 bar or 690 kilo pascals) and placed in an oven of the “roller” type for 16 hours at the desired temperature.

After the cell has been cooled down to 20° C., its contents are poured into the Hamilton bowl and mixed at 11 000 rpm for 5 minutes.

The V, F, V′ and F′ values are then determined directly in accordance with the above-described GENERAL PROTOCOL.

Said values are then compared with the abovementioned maximum values (18, 20, 10 cm³ and 10 cm³) as in the GENERAL PROTOCOL.

For an envisaged temperature in accordance with the “HTHPT” test, each tested starch is provided with the sign “+” or the sign “−” in accordance with the same conventions as those previously laid down, namely that the starch is considered to be satisfactory (“+”) only if all the values V, F, V′ and F′ are at most equal to the abovementioned maximum values.

A starch which is provided with the sign “−” at a certain temperature is not tested at any higher temperature.

### EXAMPLE 1

In this example, a certain number of starches, which are or are not in conformity with the invention, are evaluated in accordance with the above-described GENERAL PROTOCOL.

The following list gives the designation and characteristics of each product, including:

the nature of any chemical and/or physical treatment which may have been carried out for the purpose of preparing said product,

the Brookfield viscosity (8%, 20° C., 20 min, 1500 rpm) of said product as previously defined (“BV” below),

the solubility in water of said product as previously defined (“SW” below).

### LIST OF THE TESTED STARCHES

PEA 1=native pea starch (starch content>98%, amylose content: approximately 38%, protein content: approximately 0.20%)−BV<5 mPa.s, SW=0%.

PEA 2=native pea starch (starch content<98%, amylose: approximately 35%, proteins: approximately 0.50%)−BV<5 mPa.s, SW=1.1%.

PEA 3=native pea starch (starch content>98%, amylose: approximately 35%, proteins: approximately 0.35%)−BV<5 mPa.s, SW=0%.

PEA 4=PEA 1 treated on a drum dryer−BV=4550 mPa.s; SW=25.5%.

PEA 5=PEA 1 treated on a drum dryer−BV=2300 mPa.s; SW=16.2%.

PEA 6=PEA 1 treated through a nozzle and then on a drum dryer−BV=6450 mPa.s; SW=43.5%.

PEA 7=PEA 1 treated on a two-screw extruder−BV=220 mPa.s; SW=67.6%.

PEA 8=PEA 2 treated on a drum dryer−BV=4300 mPa.s; SW=19.7%.

PEA 9=PEA 2 treated through a nozzle and then on a drum dryer−BV=7500 mPa.s; SW=36%.

PEA 10=PEA 3 treated on a two-screw extruder−BV=250 mPa.s; SW=64.8%,

PEA 11=PEA 3 treated on a two-screw extruder−BV=420 mPa.s; SW=62.7%.

PEA 12=PEA 1 crosslinked with 0.1% by weight (dry/dry) of epichlorohydrin−BV<5 mPa.s; SW=0%.

PEA 13=PEA 12 treated on a two-screw extruder−BV=95 mPa.s; SW=31%.

PEA 14=PEA 1 crosslinked with 0.05% epichlorohydrin and then treated on a two-screw extruder under the same conditions as PEA 13−BV=1640 mPa.s; SW=80%.

STARCH A=potato starch treated on a two-screw extruder−BV=110 mPa.s; SW=85%.

STARCH B=potato starch crosslinked with 0.1% epichlorohydrin and then treated on a two-screw extruder−BV=880 mPa.s; SW 20%.

STARCH C=corn starch crosslinked with 0.1% epichlorohydrin and then treated on a two-screw extruder−BV=54 mPa.s; SW=4%.

STARCH D=amylose-rich corn starch (Eurylon® 7) acetylated and then treated on a drum dryer−BV=1640 mPa.s; SW=37%.

The following table gives the Brookfield viscosity (“BV”) and solubility in water (“SW”) characteristics of each of the starches tested as well as its conformity (marked “+”) or its nonconformity (marked “−”) with all the four conditions concerning the V, F, V′ and F′ values studied in accordance with the GENERAL PROTOCOL, i.e. its overall conformity or lack of conformity with the “LTLPT” test.

| | BV | | LTLPT |
|---|---|---|---|
| Product | (mPa · s ) | SW % | Test |
| PEA 1 | <5 | 0 | − |
| PEA 2 | <5 | 1.1 | − |
| PEA 3 | <5 | 0 | − |
| PEA 4 | 4550 | 25.5 | + |
| PEA 5 | 2300 | 16.2 | + |
| PEA 6 | 6450 | 43.5 | + |
| PEA 7 | 220 | 67.6 | + |
| PEA 8 | 4300 | 19.7 | + |
| PEA 9 | 7500 | 36 | + |
| PEA 10 | 250 | 64.8 | + |
| PEA 11 | 420 | 62.7 | + |
| PEA 12 | <5 | 0 | − |
| PEA 13 | 95 | 31 | − |
| PEA 14 | 1640 | 80 | + |
| STARCH A | 110 | 86 | + |
| STARCH B | 880 | 20 | + |
| STARCH C | 54 | 4 | − |
| STARCH D | 1640 | 37 | − |

This table shows that the only pea starches studied here which are capable of being in conformity with the “LTLPT” test, i.e. of exhibiting all the physical characteristics required for their being used as retention agents in accordance with the abovementioned API 13 A specification, are those which are prepared under conditions such that their Brookfield viscosity is at least equal to 100 mPa.s.

While this excludes the native products (PEA 1 to 3), it also excludes, in particular, the pea starches which, although chemically (PEA 12) or thermally (PEA 13) treated, exhibit a Brookfield viscosity which is less than 100 mPa.s. The fact that PEA 13 is not in conformity with the “LTLPT” test whereas PEA 14 is in conformity with said test shows that the quantity of crosslinking agent employed should be adjusted, i.e. in general limited, so as to enable the product, which has thus been crosslinked and then treated thermally on an extruder, to meet this requirement.

In addition, the Applicant company observed that, irrespective of its mode of preparation, a pea starch exhibiting a Brookfield viscosity greater than 20 000 mPa.s has a tendency to rapidly form a gel in aqueous solution and/or to be difficult to manipulate.

The above table also shows that an amylose-rich corn starch such as STARCH D (amylose content: approximately 70%) does not meet the requirements of the “LTLPT” test even though it exhibits a Brookfield viscosity of between 100 and 20 000 mPa.s.

Conversely, a potato starch such as STARCH A meets the requirements of the “LTLPT” test even though it exhibited a Brookfield viscosity of less than 100 mPa.s.

The above table shows that the pea starches which meet the requirements of the “LTLPT” test can independently exhibit very diverse solubilities in water, in particular between 10 and 85%.

This range excludes, in particular, the native pea starches such as PEA 1, 2 and 3 (solubility in water equal to, or close to, zero) or pea starches such as PEA 12 and 13, which are heavily modified and regarded as not meeting the requirements of the test because of their poor ability to fix or retain water.

### EXAMPLE 2

In this example, a certain number of starches, which do or do not conform to the invention, are evaluated in accordance with the above-described SPECIFIC PROTOCOL (“HTHPT” test).

The “HTHPT” test is first of all carried out at 130° C. and then at 135, 139, 141, 143 and 144° C., it being understood that a starch which does not satisfy the requirements of the “HTHPT” test at a certain temperature (for example at 141° C.) is provided with the sign “−” for this temperature, in accordance with the preestablished convention, and is not tested at any higher temperature (for example at 143 or 144° C.).

The table below shows, for each starch tested and at each temperature tested, whether said starch is in conformity (“+”) or not in conformity (“−”) with the “HTHPT” test, i.e. does or does not globally meet all the abovementioned four conditions concerning the values of V, F, V′ and F′.

| | CONFORMITY OR NONCONFORMITY WITH THE | | | | | |
|---|---|---|---|---|---|---|
| | HTLPT TEST | | | | | |
| PRODUCT | 130° C. | 135° C. | 139° C. | 141° C. | 143° C. | 144° C. |
| PEA 1 | + | + | − | − | − | − |
| PEA 2 | + | + | − | − | − | − |
| PEA 3 | + | + | − | − | − | − |
| PEA 4 | + | + | + | + | + | − |
| PEA 5 | + | + | + | + | + | + |
| PEA 6 | + | + | + | + | − | − |
| PEA 7 | + | + | − | − | − | − |
| PEA 8 | + | + | + | + | + | + |
| PEA 9 | + | + | + | + | − | − |
| PEA 10 | + | + | − | − | − | − |
| PEA 11 | + | + | − | − | − | − |
| PEA 12 | + | + | − | − | − | − |
| PEA 13 | + | − | − | − | − | − |
| PEA 14 | + | + | + | + | − | − |
| STARCH A | + | − | − | − | − | − |
| STARCH B | + | + | − | − | − | − |
| STARCH C | + | + | − | − | − | − |
| STARCH D | + | + | − | − | − | − |

This table shows that all the legume starches in conformity with the invention, namely PEA 4 to 11 and 14, not only satisfy the “LTLPT” test (cf. Example 1) but can also be used at an elevated temperature, i.e. at at least 135° C. in accordance with the “HTHPT” test. This is not the case:

with PEA 1 to 3, which are native pea starches which do not satisfy the “LTLPT” test (cf. Example 1),

with PEA 12 and 13, which are pea starches which are crosslinked with 0.1% epichlorohydrin and which, simultaneously, do not satisfy the “LTLPT” test (cf. Example 1) and do not satisfy the “HTHPT” test at 135° C.,

with STARCH A, which is an extruded potato starch which cannot be used at 135° C. in accordance with the “HTHPT” test,

with STARCH C and D, which are chemically and thermally modified corn starches which do not satisfy the “LTLPT” test (cf. Example 1).

All the legume starches according to the invention are at least as effective as STARCH B, which is a potato starch which, for the purpose of preparing it, is crosslinked with 0.1% epichlorohydrin and treated thermally. This is, in particular, the case with PEA 7, 10 and 11, which have not, however, undergone any chemical modification, in particular crosslinking, before being treated thermally for the purpose of preparation.

It should, however, be emphasized that PEA 4, 5, 6, 8 and 9 (belonging to the abovementioned FAMILY 1) and PEA 14 (belonging to the abovementioned FAMILY 2), which are in conformity with the invention and which simultaneously exhibit:

a Brookfield viscosity of between 1000 and 10 000 mPa.s., and

a solubility in water of between 12 and 80%, are still more effective since they can be used at 141° C., or even at 143 or 144° C. in accordance with the “HTHPT” test.

And it is worth emphasizing that these legume starches which have been selected in this way are capable of being used effectively as constituents of drilling fluids without there being any pressing need to modify them chemically, in particular to crosslink them.

This is all the more surprising since the literature teaches the necessity of extended crosslinking (in particular using epichlorohydrin) for starches in general to be truly utilizable at elevated temperatures.

1-14. (canceled)

15. Industrial fluid comprising a legume starch, wherein said legume starch exhibits a Brookfield viscosity of between 100 and 20 000 mPa.s.

16. Industrial fluid comprising a legume starch, wherein said legume starch exhibits a Brookfield viscosity of between 250 and 18 000 mPa.s.

17. Industrial fluid comprising a legume starch, wherein said legume starch exhibits a Brookfield viscosity of between 500 and 15 000 mPa.s

18. Industrial fluid as claimed in claim 15 wherein the legume starch exhibits a solubility in water of between 10 and 85%.

19. Industrial fluid as claimed in claim 15, wherein the legume starch exhibits a solubility in water of between 10 and 80%.

20. Industrial fluid as claimed in claim 15, wherein the legume starch exhibits a solubility in water of between 12 and 80%.

21. Industrial fluid comprising a legume starch, wherein the legume starch exhibits:
a Brookfield viscosity of between 1 000 and 10 000 mPa.s, and
a solubility in water of between 12 and 80%.

22. Industrial fluid as claimed in claim 15, wherein the industrial fluid exhibits a pH higher than 8.5.

23. Industrial fluid as claimed in claim 15, wherein the industrial fluid is intended to be used at a temperature higher than 130° C.

24. Industrial fluid as claimed in claim 15, wherein the industrial fluid is a fluid for wells.

25. Industrial fluid comprising a legume starch exhibiting a Brookfield viscosity of between 100 and 20 000 mPa.s, wherein said fluid:
exhibits a pH of between 8.5 and 12, and
is intended to be used at a temperature higher than 135° C.

26. Industrial fluid comprising a legume starch exhibiting a Brookfield viscosity of between 100 and 20 000 mPa.s, wherein said fluid:
exhibits a pH of between 9 and 11.5, and
is intended to be used at a temperature higher than 135° C.

27. Industrial fluid comprising a legume starch exhibiting a Brookfield viscosity of between 100 and 20 000 mPa.s, wherein said fluid:
exhibits a pH of between 8.5 and 12, and
is intended to be used at a temperature at least equal to 140° C.

28. Industrial fluid comprising a legume starch exhibiting a Brookfield viscosity of between 100 and 20 000 mPa.s, wherein said fluid:
exhibits a pH of between 9 and 11.5, and
is intended to be used at a temperature at least equal to 140° C.

29. A process for preparing a modified legume starch which can be used as a constituent of an industrial fluid as claimed in claim 15, wherein a legume starch is subjected to at least one chemical or physical treatment such that the resulting legume starch exhibits a Brookfield viscosity of between 100 and 20 000 mPa.s.

30. The preparation process as claimed in claim 29, wherein a native or previously modified legume starch is subjected to a physical treatment other than an extrusion treatment, in particular to a treatment on a drum dryer.

31. The preparation process as claimed in claim 29, wherein a chemically modified, in particular crosslinked, legume starch is subjected to an extrusion treatment.

32. A process for preparing a modified legume starch which can be used as a constituent of an industrial fluid as claimed in claim 18, wherein a legume starch is subjected to at least one chemical or physical treatment such that the resulting legume starch exhibits:
a Brookfield viscosity of between 100 and 20 000 mPa.s, and
a solubility in water of between 10 and 85%.

33. A legume starch which exhibits:
a Brookfield viscosity of between 2000 and 8000 mPa.s, and
a solubility in water of between 15 and 50%.

34. A legume starch which exhibits:
a Brookfield viscosity of between 500 and 1900 mPa.s, and
a solubility in water of between 30 and 80%.

35. Process for the preparation of an industrial fluid comprising a legume starch, wherein said process comprises the step of providing a legume starch exhibiting a Brookfield viscosity of between 100 and 20 000 mPa.s.

36. Process for the preparation of an industrial fluid comprising a legume starch, wherein said process comprises the step of providing a legume starch exhibiting a Brookfield viscosity of between 250 and 18 000 mPa.s.

37. Process for the preparation of an industrial fluid comprising a legume starch, wherein said process comprises the step of providing a legume starch exhibiting a Brookfield viscosity of between 500 and 15 000 mPa.s

38. Process as claimed in claim 35, wherein the legume starch exhibits a solubility in water of between 10 and 85%.

39. Process as claimed in claim 35, wherein the legume starch exhibits a solubility in water of between 10 and 80%,.

40. Process as claimed in claim 35, wherein the legume starch exhibits a solubility in water of between 12 and 80%.

41. Process for the preparation of an industrial fluid comprising a legume starch, wherein said process comprises the step of providing a legume starch exhibiting:
a Brookfield viscosity of between 1 000 and 10 000 mPa.s, and
a solubility in water of between 12 and 80%.

42. Process as claimed in claim 35, wherein the industrial fluid exhibits a pH higher than 8.5.

43. Process as claimed in claim 35, wherein the industrial fluid is intended to be used at a temperature higher than 130° C.

44. Process as claimed in claim 35, wherein the industrial fluid is a fluid for wells.

45. Process as claimed in claim 35, wherein said fluid:
exhibits a pH of between 8.5 and 12, and
is intended to be used at a temperature higher than 135° C.

46. Process as claimed in claim 35, wherein said fluid:
exhibits a pH of between 9 and 11.5, and
is intended to be used at a temperature higher than 135° C.

47. Process as claimed in claim 35, wherein said fluid:
exhibits a pH of between 8.5 and 12, and
is intended to be used at a temperature at least equal to 140° C.

48. Process as claimed in claim 35, wherein said fluid:
exhibits a pH of between 9 and 11.5, and
is intended to be used at a temperature at least equal to 140° C.

49. Process as claimed in claim 41, wherein the industrial fluid exhibits a pH higher than 8.5.

50. Process as claimed in claim 41, wherein the industrial fluid is intended to be used at a temperature higher than 130° C.

51. Process as claimed in claim 41, wherein the industrial fluid is a fluid for wells.

52. Process as claimed in claim 41, wherein said fluid:
exhibits a pH of between 8.5 and 12, and
is intended to be used at a temperature higher than 135° C.

53. Process as claimed in claim 41, wherein said fluid:
exhibits a pH of between 9 and 11.5, and
is intended to be used at a temperature higher than 135° C.

54. Process as claimed in claim 41, wherein said fluid:
exhibits a pH of between 8.5 and 12, and
is intended to be used at a temperature at least equal, to 140° C.

55. Process as claimed in claim 41, wherein said fluid:
exhibits a pH of between 9 and 11.5, and
is intended to be used at a temperature at least equal to 140° C.
